(19) United States
(12) Patent Application Publication
(10) Pub. No.: US 2009/0058082 A1
(43) Pub. Date: Mar. 5, 2009

(54) TWO-PART QUICK CONNECT RETENTION ATTACHMENT FOR FLEXIBLE TUBING IN A WATER SUPPLY SYSTEM

(76) Inventor: Ronald D. Green, New Hudson, MI (US)

Correspondence Address: Masco Corporation, 21001 Van Born Road, Taylor, MI, 48480, US

(21) Appl. No.: 11/850,133

(22) Filed: Sep. 5, 2007

(51) Int. Cl. F16L 31/00

(52) U.S. Cl. 285/222.1

(57) ABSTRACT

A flexible tube for use in a water supply system is formed of a material, such as cross-link polyethylene, which bonds best with a relatively flexible plastic. Thus, an end form that is molded or otherwise attached to the flexible tube is typically formed of a relatively flexible plastic; often also cross-link polyethylene. The flexible tubing and its end form is then connected to a housing formed of a second plastic, which is more rigid than the plastic of the end form. A water supply connection is then connected to the second housing through a quick connect fluid connection.

### BACKGROUND OF THE INVENTION

This invention relates to a flexible tubing for use in a water supply system having a relatively flexible end form received in a snap-on housing that is part of a quick connect coupling. The snap-on housing is formed of a more rigid plastic than the relatively flexible end form. The snap-on housing is connected through a quick connect connection to a water supply.

Water supply systems, such as typically utilized in a residence, include a number of outlets such as faucets. A faucet is typically provided with a shutoff valve at the wall. A handle can be turned to shut off a water supply heading to the faucet. As known, a separate shutoff handle is typical provided adjacent the faucet. Historically rigid piping connecting the shutoff valve to the faucet. More recently, flexible tubing, such as plastic tubing has been utilized.

Various connections have been proposed to connect this plastic tubing to the standard threaded connections which are utilized in known shutoff valves. As an example, for remodeling a home, it may sometimes be desirable to connect the existing threaded shutoff valve, which is manufactured for use with rigid pipe, to the new flexible tubing.

It would be desirable to utilize a quick connect fluid coupling for this connection. However, the most widely used material for the flexible tubing is such that the connection of an end form to the tubing limits the materials that can be utilized. As an example, a high percentage of the flexible tubing is formed of cross-link polyethylene or PEX. The types of materials that bond easily to the PEX are limited to relatively flexible plastics. As an example, often an end form that is bonded to the PEX tubing is also formed of PEX. Other plastics may be utilized, however, they tend to be too flexible to form a reliable quick connect fluid coupling.

### SUMMARY OF THE INVENTION

In a disclosed embodiment of this invention, a first material is utilized for an end form on a flexible tubing for a water supply system. A housing is connected to the end form through some form of connection. A water supply connection is then connected into the housing through a quick connect coupling. The housing may be formed of a second material that is more rigid than the first material of the end form. As such, the housing can form an effective fluid coupling to the water supply.

The housing may be a snap-on housing, which snaps onto the end form. Alternatively, the end form may snap into the housing. Further, the two can be simply connected together.

These and other features of the present invention can be best understood from the following specification and drawings, the following of which is a brief description.

### BRIEF DESCRIPTION OF THE DRAWINGS

FIG. 1 is a schematic of the present invention.

FIG. 2A shows a quick connect fluid coupling which may be utilized according to this invention.

FIG. 2B shows one feature of the FIG. 2A quick connect fluid coupling.

FIG. 2C shows a view of a one portion of the FIG. 2A coupling.

FIG. 3 shows yet another embodiment quick connect fluid coupling.

FIG. 4A shows yet another embodiment.

FIG. 4B shows the assembly of the FIG. 4A embodiment.

### DETAILED DESCRIPTION OF THE PREFERRED EMBODIMENT

FIG. 1 shows a water supply system 20 including a handle 22 for turning a shutoff valve 24. As is known, the handle 22 is typically mounted in a wall, and communicates an inlet 26 to a water supply 28. Water is supplied from the water supply 28 into the inlet 26, and through the valve 24, into a threaded nipple 30. As shown here, nipple 30 is internally threaded at 36. In this embodiment, an adaptor 34 is threaded at 38. This adaptor allows a quick connect fluid connection 42 to connect a flexible tubing 31 which extends to an outlet such as a faucet 32. The quick connect fluid coupling 42 is shown schematically here.

The adaptor 34 includes an outwardly extending bead 40 which is received beyond snapping fingers 44 on the quick connect fluid coupling 42. The snapping fingers 44 are shown as one example. As is known, a quick connect fluid coupling typically has some moving element which snaps behind a surface, such as bead 40, on a tube or fitting, such as adaptor 34, to quickly secure the adaptor 34 in a fluid tight manner.

With this embodiment, the adaptor 34 can be easily connected to the nipple 30 such that an existing shutoff valve can be easily and quickly connected to a quick connect fluid connection, and the flexible tubing 31. Of course, the adaptor can be utilized with new construction also. The adaptor is well suited for easily allowing the use of the standard threaded nipple, and to connect it to a quick connect fluid coupling.

More details of other adaptors which may be utilized in this invention are disclosed in co-pending U.S. patent application Ser. No. ______ filed on even date herewith, and naming the inventors of the present application, and entitled “Adaptor for Quick Connect Coupling in Water Supply System.”

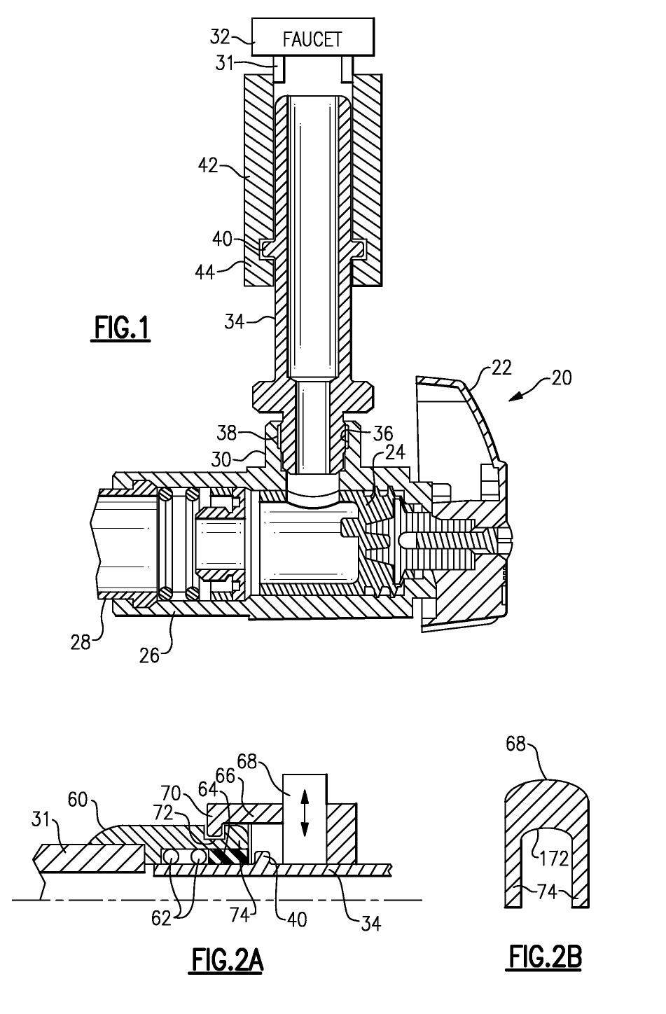

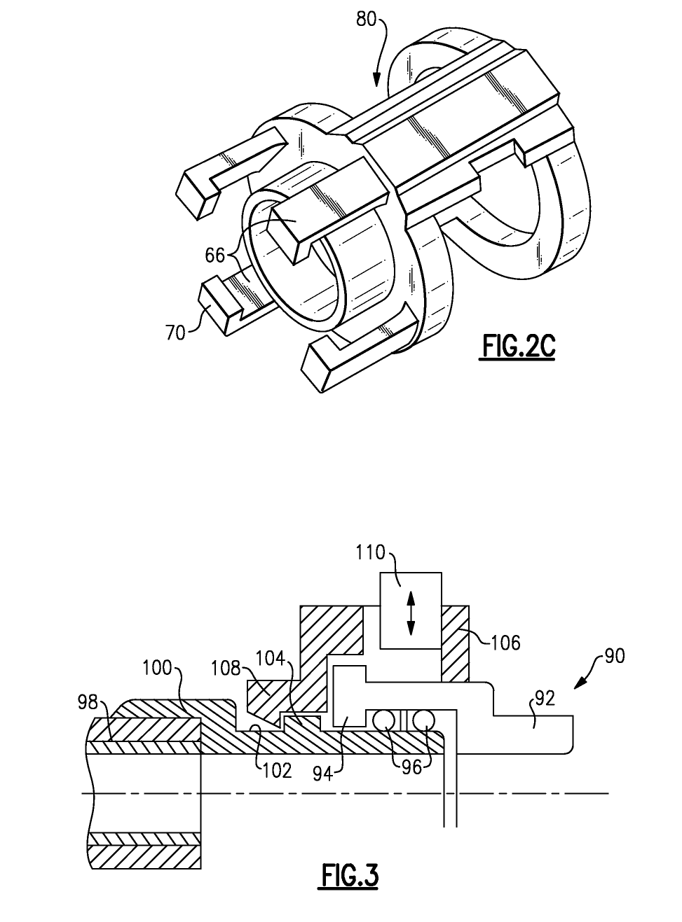

FIG. 2A shows one embodiment quick connect fluid coupling as may be utilized within this invention. As shown, the flexible tubing 31 has an over-molded or spun weld end form. Seals 62 seals on an outer surface of the adaptor 34. Plug 64 serves to retain seals 62 until the entire connection is assembled. The example quick connect fluid coupling has a two-part housing, including the end form 60, and a second snap on housing 66. Snap-on housing 66 includes forward snapping fingers 70 which snap beyond a head 74, and into a groove 72 in the end form 60.

Since the snap-on housing 66 is formed separately, it can be formed of a rigid material. A retainer 68 may be as shown in FIG. 2B, and includes a securing portion 172 and legs 74. The legs 74 move into side slots in the housing 66, and the portion 172 is moved behind the bead 40 to secure the adaptor 34 within the housing 66. Thus, and is generally known in the quick connect art, the retainer 68 is generally moved upwardly as shown in this figure, and the adaptor 34 and its bead 40 can be moved freely into the housing 66. The retainer 68 is then moved downwardly as shown in this figure, and catches the bead 40. Retainers that have snapping fingers could also be used to hold the adapter.

The flexible tubing 31 is typically formed of a plastic such as cross-link polyethylene, or PEX. The end form 60 is typically formed of a plastic that secures easily to the flexible tubing 61. Thus, the end form is often also formed of PEX. The flexible material of the end form is too flexible to form an effective mechanical connection in a quick connect fluid coupling. Thus, the snap-on housing 66 provides the ability for a more rigid plastic to secure the adaptor 34.

FIG. 2C is a perspective view of the snap-on housing 66, showing fingers 70, and the space 80 to receive the retainer 68.

FIG. 3 shows another embodiment 90 wherein the adaptor 92 has a forward bead 94. Seals 96 are secured between the adaptor 92 and the end form 100. The end form 100 is attached to the flexible tubing 90, as in the first embodiment. The second housing 106 includes a snapping finger 108, which snaps into a ditch 102 in the end form, and around a bead 104.

The FIGS. 2A-C and FIG. 3 are simply examples of two-piece quick connect fluid couplings. The application would extend to any flexible tubing that includes an end form formed of a first relatively flexible plastic, and a second housing snapped onto the end form wherein the second housing is formed of a more rigid plastic, and the second housing is used to provide a quick connect fluid connection to a water supply.

As an alternative to snapping the housing onto the end form, the housing could be formed with a generally cylindrical rigid component rather than the snapping fingers. The housing can then be placed on the leftward side of the flexible tubing, with the retainer 68 removed. The housing can then be slid along the flexible tubing until it catches on the end 74 of the end form. The retainer 68 may then be moved into the housing to secure the adapter 34.

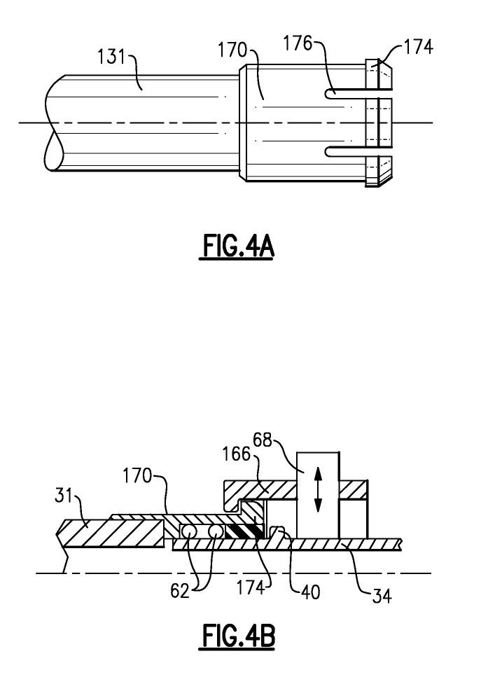

As shown in FIGS. 4A and 4B, in another embodiment, the flexible tubing 131 may have its end form 170 formed with the resilient fingers 174 having circumferentially spaced slots 176. Thus, the fingers 174 may snap into the end of the housing 166.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A water supply system comprising:
a flexible tubing having an end form attached to one end of the flexible tubing, ; and
a housing removably attached to the end form.

2. The water supply system as set forth in claim 1, wherein the end form is formed of a relatively flexible first plastic and the housing is formed of a second plastic that is more rigid than said first plastic.

3. The water supply system as set forth in claim 2, wherein said housing has fingers that snap onto said end form.

4. The water supply system as set forth in claim 1, wherein said end form has resilient fingers that snap into a surface on said housing.

5. The water supply system as set forth in claim 1, wherein said housing is slid onto an opposed end of said flexible tubing from said end form, and moved along said flexible tubing to abut said end form.

6. The water supply system as set forth in claim 1, wherein an adaptor is inserted into said housing, and the retainer is moved within said housing to secure said adaptor.

7. The water supply system as set forth in claim 6, wherein seals provide a fluid-tight seal between said end form and said adaptor.

8. The water supply system as set forth in claim 6, wherein said adaptor is secured radially within said end form.

9. The water supply system as set forth in claim 6, wherein said adaptor is positioned radially outwardly of said end form.

10. A water supply system comprising:
a valve housing having a handle for turning a valve, and controlling flow of fluid through the valve housing from a source to an outlet;
a connection for connecting said valve housing to an outlet, and an adaptor as part of said connection; and
a quick connect fluid coupling coupling a flexible tubing to said adaptor, said flexible tubing including an end form attached to one end of the flexible tubing, with said end form formed of a relatively flexible first plastic, and said quick connect fluid coupling including a housing snap fit to said end form, said housing formed of a second plastic material that is more rigid than said first plastic material, and said adapter being secured within said housing by a quick connect fluid coupling.

11. The water supply system as set forth in claim 10, wherein said housing has fingers that snap onto said end form.

12. The water supply system as set forth in claim 10, wherein said retainer is moved within said second housing to secure said adaptor.

13. The water supply system as set forth in claim 10, wherein seals provide a fluid-tight seal between said end form and said adaptor.

14. The water supply system as set forth in claim 10, wherein said adaptor is secured radially within said end form.

15. The water supply system as set forth in claim 10, wherein said adaptor is positioned radially outwardly of said end form.
